(19) United States
(12) Patent Application Publication
(10) Pub. No.: US 2015/0103885 A1
(43) Pub. Date: Apr. 16, 2015

(54) REAL TIME IP VIDEO TRANSMISSION WITH HIGH RESILIENCE TO NETWORK ERRORS

(71) Applicant: ooVoo LLC, New York, NY (US)

(72) Inventors: Chang Feng, Belle Mead, NJ (US); Minyi Yang, Rego Park, NY (US)

(21) Appl. No.: 14/511,871

(22) Filed: Oct. 10, 2014

Related U.S. Application Data
(60) Provisional application No. 61/889,982, filed on Oct. 11, 2013.

(51) Int. Cl. H04N 19/164; H04L 12/26; H04N 19/107; H04N 19/169; H04N 19/66

(52) U.S. Cl. CPC H04N 19/00236; H04N 19/00327; H04N 19/0086; H04N 19/0003; H04L 43/062; H04L 43/0835
USPC 375/240.02

(57) ABSTRACT

A method and system related to video transmission to increase resiliency to network errors, such as packet loss. Packet loss can lead to low quality or broken audio, pixilation, image freeze, and other distortions of a video signal. The system and method utilizes packet retransmission and FEC in combination to increase error recovery. Further, the system and method takes into account unique data source characteristics in order increase resilience to network error while minimizing overhead. Finally, the system and method takes into account network conditions, especially in networks with heterogeneous conditions, by separating uplinks and downlinks and adjusting to each individual link in order to provide optimal protection for each link.

### RELATED APPLICATIONS

This application claims priority from U.S. Provisional Application No. 61/889,982 filed Oct. 11, 2013.

### TECHNICAL FIELD

The present invention relates generally to video transmission systems and specifically to methods and systems for video transmission over fixed and/or mobile packet networks.

### BACKGROUND

Typical video transmission systems generally include a video source (e.g., a video camera), video encoder, transmission method (e.g., the Internet, LANs, and/or telephone lines), video decoder, and video renderer (e.g., a computer monitor or television set). Video transmission systems are generally used to transfer audio, video, and/or other data between remote parties. Video transmission may include live streaming, which allows remote parties to transmit and receive video transmission in real time, and video teleconferencing (also referred to as video conferencing), which allows two or more remote parties to participate in a discussion.

Data transmitted in a video transmission system may be formatted in data packets rather than bit streams for transmission over a network. When compressing the video data into frames, inter-frame or intra-frame compression can be used. Inter-frame compression means that each frame references surrounding frames in order to produce images in the proper order. Intra-frame compression creates frames that contain all information needed to produce an image temporally.

Transmission systems utilize transport level protocols, such as the Unreliable Datagram Protocol (UDP), to deliver the data packets. Many of these protocols, such as UDP, do not guarantee delivery of data packets. On many networks, packet loss is common, which can cause degradation to the quality of the audio and video transmission. This degradation is experienced as low quality or broken audio, pixilation, image freeze, and other distortions of the video signal.

One method to control for packet loss is packet retransmission. This method requires that the sender retains the transmission in a buffer until the receiver acknowledges successful receipt. In the instance of packet loss, the receiver may signal to the sender to retransmit the full video transmission or the affected packets. Additionally, if after a designated time the sender does not receive a signal from the receiver, the sender may retransmit the full video transmission. However, packet retransmission is unsuitable for many real world applications because retransmission may result in long delays and/or excessive transmission bandwidth overhead.

Another method to control for packet loss is forward error correction (FEC). In FEC, the transmission is encoded with redundancy, which allows the receiver to detect a limited number of errors. FEC has the advantage of being able to correct errors without needing a reverse channel to request retransmission of data. It works best when dealing with consistent and predictable levels of packet loss. However, real world situations rarely exhibit packet loss that is consistent and/or predictable. Therefore, FEC provides an error correction method that results in significant bandwidth overhead without much benefit in protecting against packet loss.

Both packet retransmission and FEC operate at the channel level. They are unaware of the nature of the data source they are employed to protect. For instance, if used for digital video transmission, these methods do not take into account the unique characteristics of prediction based video coding, leaving such transmission systems to achieve sub-optimal results.

Packet retransmission and FEC are also designed and deployed orthogonally, meaning that they operate independently of each other. However, real world systems utilize both methods over the same network connections. Further, packet retransmission and FEC only address one-to-one transmission systems and do not perform well when utilized in multipoint transmission systems with various transmission qualities for each receiver. By not taking into these characteristics of the network, the system again achieves sub-optimal results.

The present system and method combines FEC and packet retransmission to significantly enhance a video transmission system's resilience to network errors, specifically packet loss. The present system and method further presents a method of optimization based on the type of transmission system it is being used for, such as digital video transmission. The present system and method combines FEC and packet retransmission that yields superior audio and video quality to previous video transmission systems.

### SUMMARY

Examples of the present invention that are described herein provide methods, systems, and software for use in packet-based video transmission. These methods permit both fixed and/or mobile client devices to exchange video images and audio data via a transmission method (e.g., the Internet). Both multiple-point transmission including a server and point-to-point transmission are supported. The video transmission system includes a video source, such as a video camera, linked to a video encoder that compresses and produces data packets that are transmitted over the transmission method, such as the Internet. The packets can go directly to a single receiving device or to a server that receives and transmits the packets to other receiving devices. The receiving devices use a video decoder to reassemble the packets and reproduce the original data. If packets are lost or delayed, the received audio and video quality may suffer. The present system and method is highly resistant to such errors.

An object of the disclosed system and method is to provide a video transmission system that is highly resistant to a wider range of network errors, such as packet loss, and increase error recovery. This may be accomplished by providing a system and method where packet retransmission and FEC methods are used in combination.

A second object of the disclosed system and method is to provide a video transmission system where the system takes into consideration the unique characteristics of the transmission's data source. This may be accomplished by providing a system and method whereby joint source content is utilized. This may be further accomplished by providing a system and method whereby dynamic FEC based on source data and network conditions optimize the video quality while minimizing overhead.

A third object of the disclosed system and method is to provide a multipoint transmission system with enhanced error resilience and minimized bandwidth overhead. This may be accomplished by providing a system and method whereby the uplink and downlink are separated. This allows the error resilience techniques to be tailored to each individual link.

A fourth object of the disclosed system and method is to provide a network error resiliency method which receives a video transmission; encodes the video transmission into source video packets; transmits the source video packets; stores the source video packets in a retransmission buffer; uses forward error correction to encode the source video packets into FEC repair packets; transmits the FEC repair packets; receives the source video packets, which are held in a receiver buffer, and the FEC repair packets, which are held in a FEC decoder; repairs received source video packets using the FEC repair packets; requests a retransmission of any source video packets that could not be repaired by the FEC repair packets; and renders received source video packets and repaired source video packets into a video demonstration.

A fifth object of the disclosed system and method for transmitting a video transmission which receives video frames; pre-processes the video frames to create pre-processed video frames; encodes the pre-processed video frames into video packets; stores the video packets in a retransmission buffer; codes the video packets with forward error coding to create repair packets; transmits the video packets and repair packets; waits for a return message either acknowledging receipt of the video packets or reporting missing video packets, wherein if a return message is not received before a designated time interval, retransmits the video packets in the retransmission buffer and repair packets; retransmits any video packets in the retransmission buffer indicated by the return message; and purges the retransmission buffer of the video packets once the return message indicates the video packets were received.

A sixth object of the disclosed system and method for receiving a video transmission which receives a transmission comprising a video transmission and a forward error correction transmission of the video transmission; stores the forward error correction transmission in a FEC decoder and stores the video transmission in a received buffer; repairs transmission errors in the video transmission stored in the received buffer with the forward error correction transmission stored in the FEC decoder to create a repaired video transmission; stores the repaired video transmission in the received buffer; sends a message requesting a retransmission of the transmission, focusing on the portions of the transmission containing errors, if the transmission errors cannot be repaired with the forward error correction transmission; decodes the video transmission stored in the receiver buffer to create a decoded video transmission; post processes the decoded video transmission to create a post-processed video transmission; and renders the post-processed video transmission into a video presentation.

A seventh object of the disclosed system and method for receiving and sending a video transmission in a conference environment which receives a transmission comprising a video transmission and a forward error correction transmission of the video transmission; stores the forward error correction transmission in a FEC decoder and stores the video transmission in a received buffer; repairs transmission errors in the video transmission stored in the received buffer with the forward error correction transmission stored in the FEC decoder to create a repaired video transmission; stores the repaired video transmission in the received buffer; sends a message requesting a retransmission of the transmission, focusing on the portions of the transmission containing errors, if the transmission errors cannot be repaired by the forward error correction transmission; receives a retransmission comprising a video retransmission and a forward error correction retransmission of the video retransmission; stores the forward error correction retransmission in the FEC decoder to create a repaired FEC transmission and stores the video retransmission in the received buffer; repairs transmission errors in the video transmission and video retransmission stored in the received buffer with the forward error correction transmission and forward error correction retransmission stored in the FEC decoder; stores the repaired video transmission in the received buffer; sends a message requesting a retransmission of the retransmission, focusing on the portions of the retransmission containing errors, if the transmission errors cannot be repaired by the forward error correction retransmission; and transmits the repaired video transmission stored in the receiver buffer and the repaired FEC transmission stored in the FEC decoder.

The present system and method will be more fully understood from the following detailed description of the examples thereof, taken together with the drawings.

### BRIEF DESCRIPTION OF THE DRAWINGS

FIG. 1 shows a schematic, pictorial illustration of a system for video transmission between mobile and fixed client devices, in accordance with an example of the present system.

FIG. 2 shows a schematic, pictorial illustration of a system for video teleconference, in accordance with another example of the present system.

FIG. 3 shows a flow chart that generally illustrates a point-to-point example of the present system.

FIG. 4 shows a flow chart that schematically illustrates an example of a sender in the present system.

FIG. 5 shows a flow chart that schematically illustrates an example of a receiver in the present system.

FIG. 6 shows a flow chart that schematically illustrates a point-to-multipoint example of the present system.

FIG. 7 shows a flow chart that schematically illustrates a multiuser conference example of the present system.

FIG. 8 shows a simplified flow chart that schematically illustrates an example of a multi-sender in the present system.

FIG. 9 shows a flow chart that generally illustrates the sender QoS manager of an example of the present system responding to a receiver report.

FIG. 10 shows a flow chart that generally illustrates the receiver QoS manager of an example of the present system.

FIG. 11 shows a flow chart that generally illustrates the sender QoS manager of an example of the present system monitoring the retransmission buffer.

FIG. 12 shows a flow chart that generally illustrates the receiver QoS manager of an example of the present system incorporated into a server.

FIG. 13 shows a flow chart that generally illustrates the sender QoS manager of an example of the present system incorporated into a server.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various technologies described herein generally relate to video transmission and more specifically to methods and systems for video transmission over packet networks with end points, such as personal computers and mobile devices. The method and system described herein may be used to create a video transmission that is highly resilient to network errors by utilizing a dual source channel that transmits packets simultaneously using both packet retransmission and FEC. In the multiuser instance in which a server is used, the system and method of a dual source channel that transmits packets simultaneously using both packet retransmission and FEC is expanded to the server. Further, the present system and method allows the server to separate the individual uplinks and downlinks in order to tailor the system and method to each individual link.

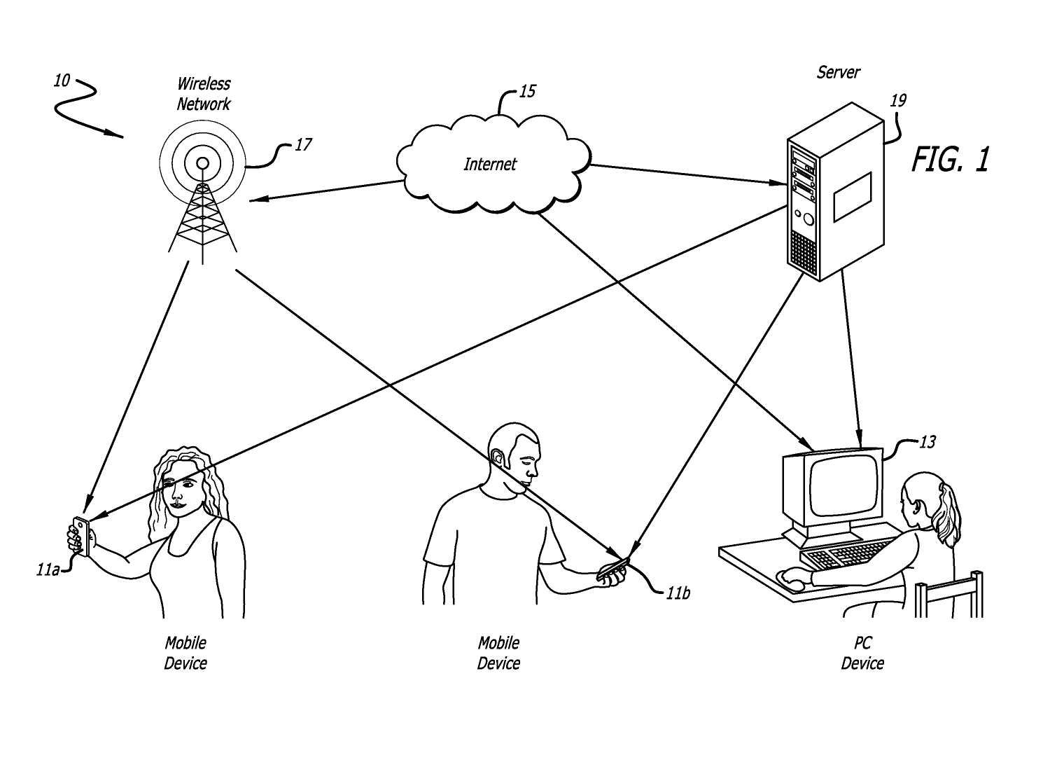

FIG. 1 illustrates a high-level schematic of one example of a video transmission system 10 for video transmission between multiple devices, for example one or more mobile devices 11a, 11b (generally referred to as 11) and one or more personal computer (PC) fixed devices 13. Each fixed device 13 and mobile device 11 is capable of encoding and decoding video transmissions. The mobile devices 11 may send data and communicate over the Internet 15 with other devices mobile 11 and fixed devices 13 via a wireless communications network 17. The wireless communications network 17 may be a long range network, such as a 3G network, 4G network, or LTE network, a short range network, such as WiFi or Bluetooth, or any other network protocol or combination of such networks. In the case of some wireless communications networks, a wireless network tower may also be used. As shown in FIG. 1, logically each device may communicate with each other by sending data to and receiving data from a server 19. In one example, the server 19 may be an audio server, a video server, or an audio/video server (AVS). It is also understood that the system may include one or more dedicated servers, such as a dedicated audio server and a dedicated video server. The functionality of the server 19 may also be incorporated into other network devices as known to those of ordinary skill in the art.

Generally, the server 19 includes a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements to enable communications, such as controllers, buffers (caches), drivers, repeaters, and receivers, which are omitted for simplicity but known to those of skill in the art. Further, the local interface may include address, control, and/or data connections to enable appropriate communications among the other computer components.

The I/O devices may include input devices, for example but not limited to, a keyboard, mouse, scanner, microphone, touch screens, bar code readers, stylus, laser readers, and radio-frequency device readers. Furthermore, the I/O devices may also include output devices, for example but not limited to, a printer, bar code printers, and displays. Finally, the I/O devices may further include devices that communicate both inputs and outputs, for instance but not limited to, a modulator/demodulator (modem; for accessing another device, system, or network), a radio frequency (RF) or other transceiver, a telephonic interface, a bridge, and a router.

The processor of the server 19 is a hardware device for executing software, particularly software stored in memory. The processor can be any custom made or commercially available processor, a central processing unit (CPU), an auxiliary processor among several processors associated with the server 19, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc., or a 68xxx series microprocessor from Motorola Corporation.

The memory can include any one or a combination of volatile memory elements (e.g., random access memory (RAM, such as DRAM, SRAM, SDRAM, etc.)) and nonvolatile memory elements (e.g., ROM, hard drive, tape, CDROM). Moreover, memory may incorporate electronic, magnetic, optical, and/or other types of storage media. The memory can have a distributed architecture where various components are situated remote from one another but can also be accessed by the processor.

The software in memory may include one or more separate programs, each comprising an ordered listing of executable instructions for implementing logical functions. An example of suitable commercially available operating systems is Windows operating system available from Microsoft Corporation. The operating system controls the execution of computer programs. It is understood that other operating systems may also be utilized without departing from the spirit of the system and method disclosed herein.

If the server 19 is a PC or workstation, the software in the memory may further include a basic input output system (BIOS). The BIOS is a set of essential software routines that initialize and test hardware at startup, start the O/S, and support the transfer of data among the hardware devices. The BIOS is stored in ROM so that the BIOS can be executed when the server 19 is activated.

Video transmission may require real-time, two-way transmission of video and audio data. In the Internet environment, the real-time two-way transmission may be complicated by intermediary components, such as a firewall. Firewalls are typically used, as is known in the art, to prevent malicious traffic on the Internet 15 from reaching mobile devices 11 and fixed devices 13. As a result, the firewall may prevent packets that are sent using simple, connectionless transport level protocols, such as UDP, from reaching computer 13. UDP could otherwise be used conveniently and efficiently for transmitting real-time data. Other sorts of intermediary components, such as proxy servers (not shown), may cause similar sorts of problems. In such cases, it may be necessary for the server to use a connection-oriented transport level protocol, such as the Transmission Control Protocol (TCP), or possibly even a secure socket to transmit audio and video data downstream to the client computer.

Server 19 may be configured to determine the appropriate and most efficient transport layer protocol to use for each client computer for a given video transmission. The server may thus use TCP, with or without a secure socket, to communicate with one mobile device 11 or fixed device 13 in a given conference, while using UDP to communicate with another mobile device 11 or fixed device 13 in the same conference. The devices are typically not aware of these differences in transport layer protocol. Thus, system 10 may support both point-to-point and multipoint-to-multipoint conferences in which different client computers simultaneously use different transport layer protocols.

When the server 19 is in operation, the processor is configured to execute software stored within the memory, to communicate data to and from the memory, and to generally control operations of the server 19 based on the software. Processor, mobile device 11, and/or fixed device 13 perform the functions, as described herein, under the control of an error resiliency computer program, which may be downloaded in electronic form (over a network, for example), or may be provided on tangible media, such as optical, magnetic, or electronic memory media.

The error resiliency computer program with support and compliance capabilities may be a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, the error resiliency computer program with support and compliance capabilities can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada. In one example, the error resiliency computer program with support and compliance capabilities is written in C++. The error resiliency computer program may be stored at any location in the present system, including server 19, mobile device 11, and/or fixed device 13.

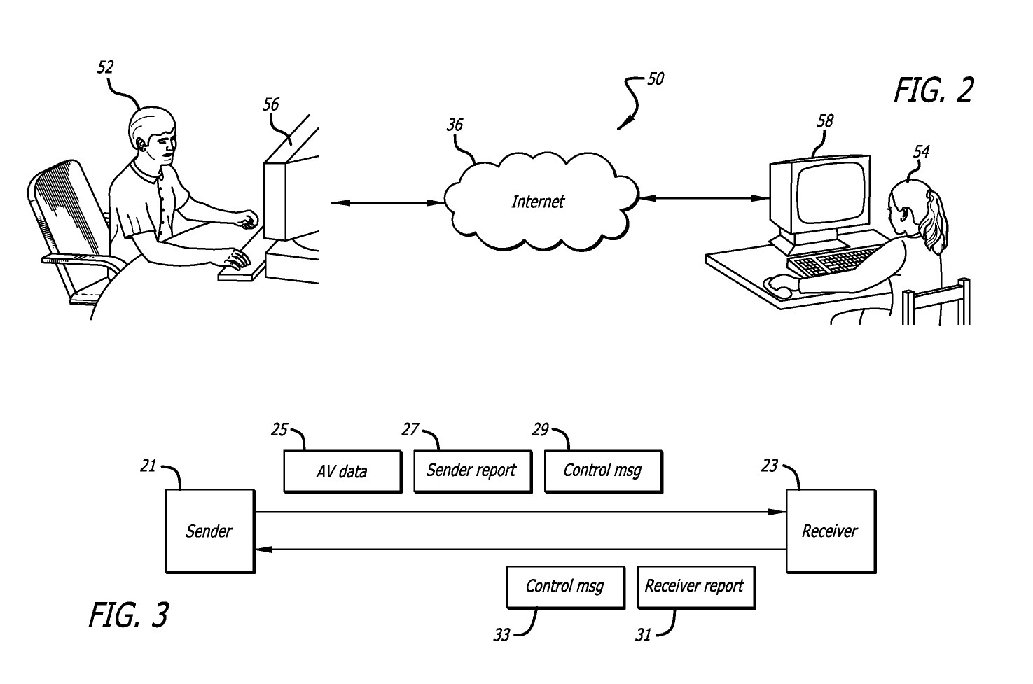

FIG. 2 is a schematic, pictorial illustration of a system 50 for a video transmission system, in accordance with another example of the present system. Users 52 and 54 of respective computers 56 and 58 participate in a point-to-point video transmission over network 36. In this example, computer 56 acts as both client and server. The principles of this example may similarly be applied in point-to-multipoint and multipoint-to-multipoint video transmission, as long as the computer acting as the server has sufficient computing power to support multiple clients.

Although the methods that are described herein make reference specifically to the elements of system 10 (FIG. 1), these methods may likewise be applied, mutatis mutandis, in system 50 as well as in other point-to-point, point-to-multipoint, and multipoint-to-multipoint video transmission topologies.

FIG. 3 is a flow chart that generally illustrates an example of a point-to-point example of the present system. In this example, the system consists of a sender 21 and a receiver 23. Both components and their functioning are described in greater detail below. Generally, the sender 21 provides audio and/or video data 25, a sender report 27, and a control message 29 to the receiver 23. The receiver 23 renders the data and returns a receiver report 31 and a control message 33 to the sender 21 acknowledging receipt or transmission errors.

In the present example, when the sender 21 transmits data packets to the network 17, it adopts a traffic smoothing technique to prevent peak bandwidth impact on the network 17. The sender 21 transmits one packet segment at a time and waits for a transmission interval time before transmitting the next packet segment. For example, the transmission interval time value may be determined by the lesser of two thirds of the video frame's duration time and a maximum delay constraint.

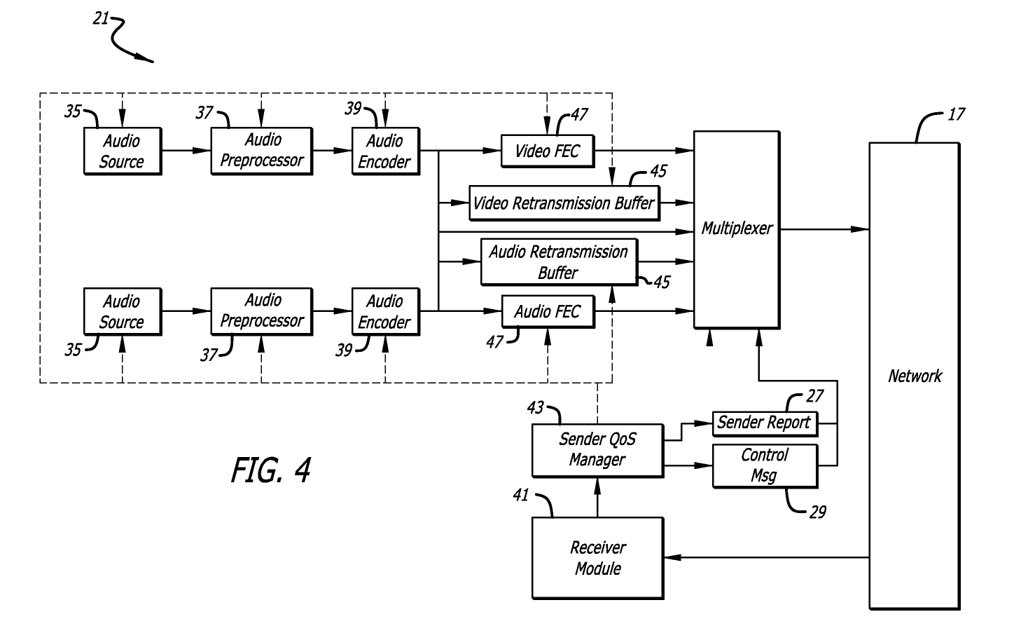

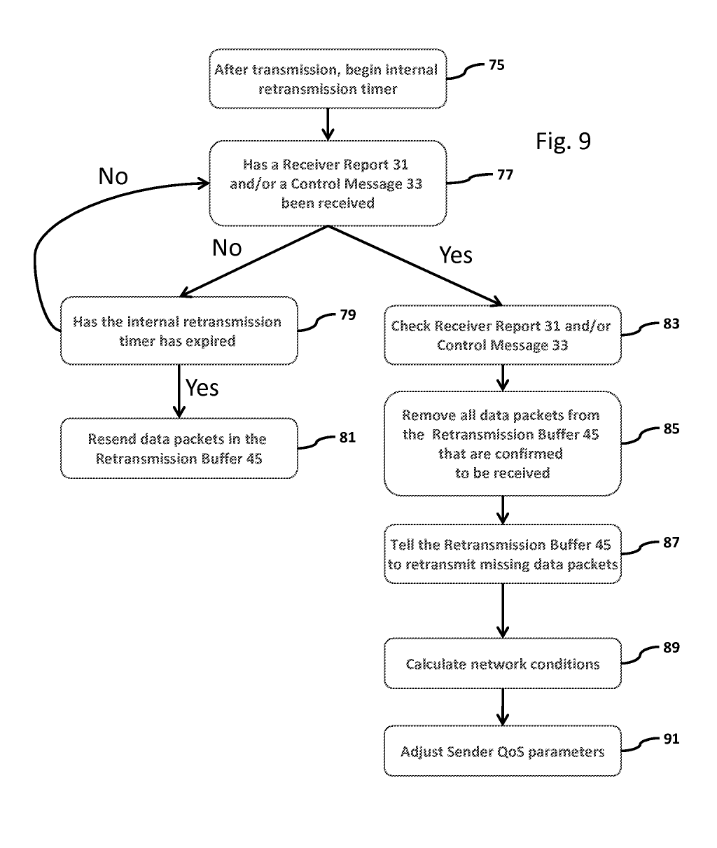

FIG. 4 is a flow chart that schematically illustrates an example of a sender 21 in the present system. In a sender 21, video frames are provided from a video source 35, such as captured from a video camera. These frames are optionally separated into video data and audio data components 35 that are then sent to pre-processers 37. After pre-processing, the video and audio components are sent to respective encoders 39, in which the compressed data is divided into a series of data packets suitable for IP network transmission. In the present example, the video data and audio data go through separated video/audio data packet and FEC repair packet paths. In the video/audio packet path, the video and audio data packets are sent out to the network 17, either directly or further multiplexed with other data packets sent by the sender module 49. The video and audio data packets are also then saved into respective retransmission buffers 45. In the FEC repair path, the packets are processed by respective FEC encoders 47 to generate the desired number of FEC repair packets. The FEC repair packets are then sent out to the network 17 in a similar fashion as the video and audio data packets. After transmission, a sender quality of service (QoS) manager 43 maintains an internal retransmission timer (see 75 of FIG. 9). When this timer expires, the sender 21 may send out all video and audio data packets in the retransmission buffers 45 (see 81 of FIG. 9). In some instances, this is done if the sender 21 does not receive a receiver report 31 from the receiver 23 in a designated amount of time (see 79 of FIG. 9).

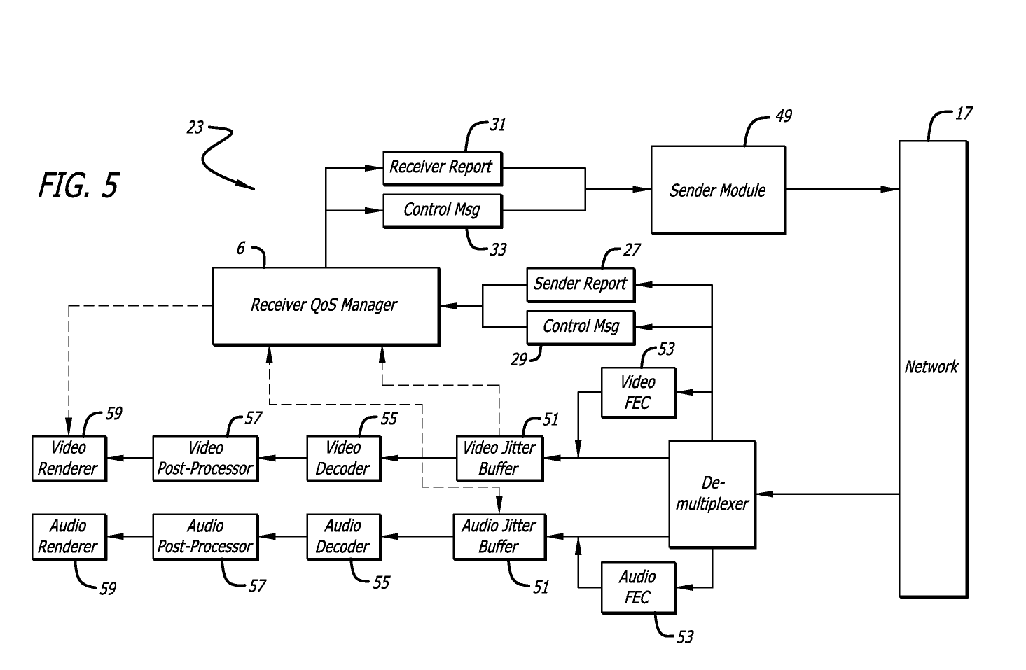

FIG. 5 is a flow chart that schematically illustrates an example of a receiver 23 in the present system. A receiver 23 receives a sequence of video and audio data packets and FEC repair packets, de-multiplexing them if necessary. Video and audio data packets are stored into respective receiver jitter buffers 51. FEC packets are stored in the respective FEC decoders 53. The FEC decoders 53 monitor the receiver jitter buffers 51 and recover missing video and audio data packets when capable. The recovered video and audio data packets are then stored in the respective receiver jitter buffer 51 with the video and audio data packets received from the network 17. When there are enough in-sequence video and audio data packets in the receiver jitter buffers 51, meaning all packets are present in the receiver jitter buffers 51 according to their sending order, the video and audio data packets are sent to the decoder 55, post-processer 57, and renderer 59.

In the receiver 23 of the present example, the decoder 55 decodes all frames regardless of their due playback time and sends the decoded frames to the video post-processor 57 and video renderer 59. In this manner, all decoded frames are rendered regardless of their due playback time.

In another example of the present system, the received video frames are sent from the decoded 55 to the post-processor 57 and renderer 59 at their due playback time. When a currently due video frame in the receiver jitter buffer 51 is incomplete (i.e., missing data packets), the decoder 55 pauses. The decoder 55 may resume when certain conditions are met, for example:
The paused frame, which is also the oldest frame in the receiver jitter buffer 51, has received the missing packet(s) and is now complete. In this case, the decoder 55 decodes the frame and any completely received subsequent frames in the receiver jitter buffer 51 until it reaches another incomplete frame or a frame whose playback time is not due yet.
A complete frame in the receiver jitter buffer 51 that is decodable, independent of the paused frame, is due or past due for playback. In this case the frames between the paused frame and the resuming frame are purged. The decoder 55 decodes the resuming frame to continue its normal operation.

In either example, the decoder 55 does not send decoded frames with playback timestamps that are past due since this would create a jerkiness or fast forward effect of the video output. In another example of the present system, the decoder 55 may use an error threshold or specific condition to determine whether a frame is complete. If the error is less than the threshold or does not meet a specific condition, the decoder 55 considers the frame complete and sends it on. In this manner, low level noise may be filtered from the system.

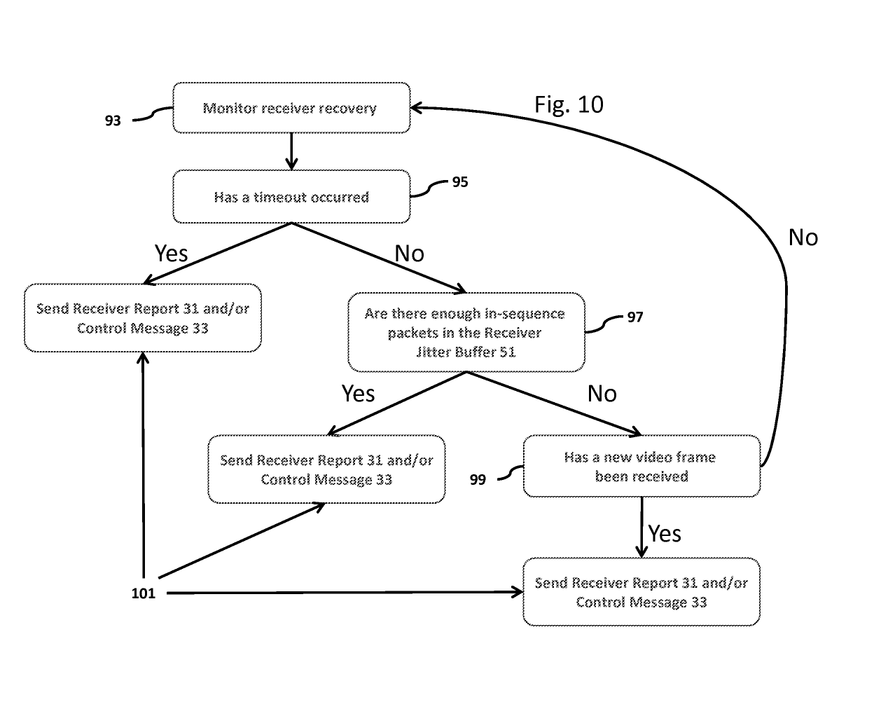

The receiver QoS manager 61 monitors the receiver recovery process (91 of FIG. 10). FIG. 10 shows a flow chart illustrating an example of the receiver QoS manager 61. The receiver QoS manager 61 may send (101) a receiver report 31 and/or control message 33 to the sender 21 when one of the following conditions are met:
A timeout occurred, meaning a time interval within which a receiver report 31 and/or control message 33 must be sent (95);
There are enough in-sequence data packets in the receiver jitter buffer 51 (97); or
A data packet from a new video frame is received (99).

The receiver report 31 and/or control message 33 may contain the following information:
Acknowledgement of the latest in-sequence data packets received;
Report of missing data packets in the receiver jitter buffer 51; and/or
Other control information related to the receiver status, such as receiver jitter buffer 51 queue length.

The receiver report 31 and/or control message 33 is received by the sender 21 through the receiver module 41 and passed to the sender QoS manager 43. FIG. 9 shows a flow chart illustrating an example of the sender QoS manager 43. As stated above, after transmission, the sender QoS manager 43 begins an internal retransmission timer (75). If sender QoS manager 43 receives (77) a receiver report 31 and/or control message 22, it checks the contents of the report and does at least one of the following actions (83):
Removes from the retransmission buffer 45 all data packets that are confirmed to have been received (85);
Retransmits data packets that are reported missing by receiver 23, which are marked so subsequent reports of the same missing packet will be ignored for a period of time before another retransmission is attempted (87); and/or
Calculates and/or estimates network conditions (89), and adjusts sender QoS system parameters accordingly (91).

The sender QoS system parameters comprise network loss conditions based on a round trip time (RTT) measurement, receiver report 31, retransmission queue length, and retransmission rate. The sender QoS manager 43 may use these system parameters to dynamically adjust the FEC encoder 47 to apply the optimal amount of protection to the data stream. For instance, it may adjust the video source rate by changing:
Video encoder bit rate setting;
Video source input rate, such as the camera capture frame rate; and/or
Amount of video preprocessing applied.

During retransmission, data packets labeled for retransmission are sent to FEC encoder 47 to generate FEC repair packets for the retransmitted data packets. Both retransmission data packets and retransmission FEC repair packets will be sent to the network 17 directly or multiplexed with other packets to be sent by the receiver 23.

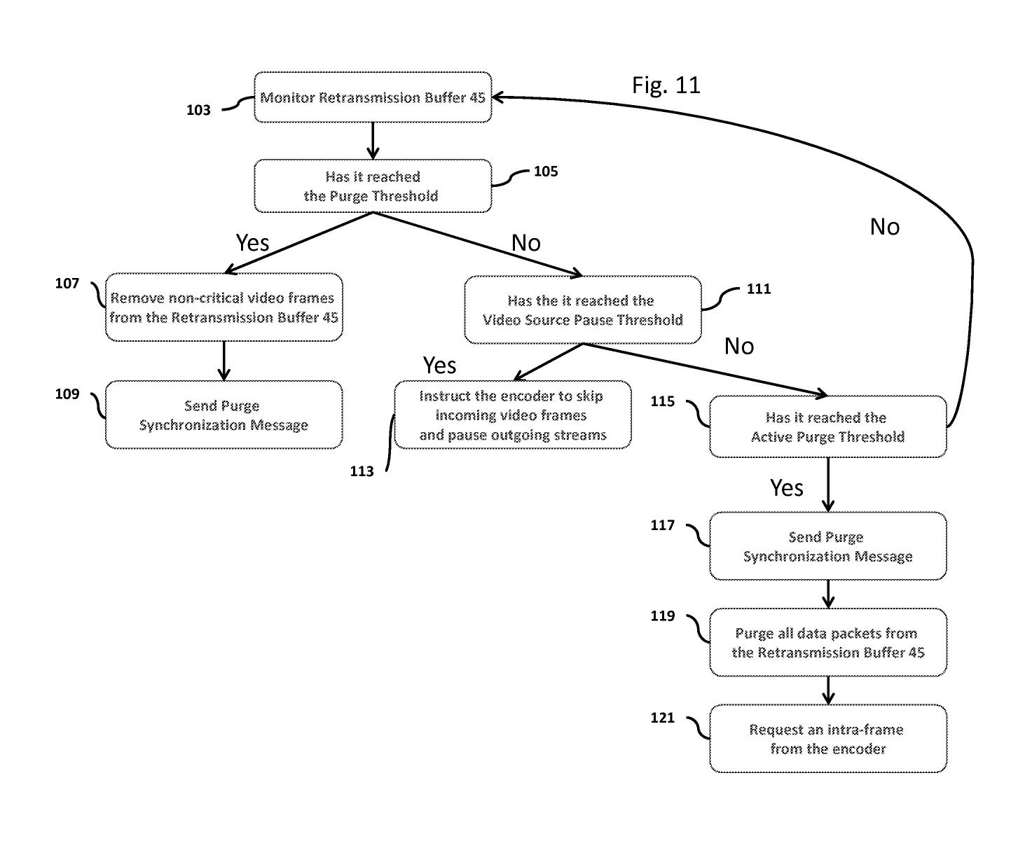

The sender QoS manager 43 also may monitor the retransmission buffer 45 for a set of parameters that can be set by the user. FIG. 11 shows a flow chart generally illustrating the sender QoS manager 43 monitoring the retransmission buffer (103) based on the following exemplary parameters:
Purge Threshold;
Video Source Pause Threshold; and/or
Active Purge Threshold.

If the retransmission buffer 45 reaches and/or goes above the Purge Threshold (105), the sender QoS manager 43 may remove non-critical video frames in the retransmission buffer (107). In the present example, “non-critical” means the frame is not required for the proper sequential decoding of subsequent frames. After purging the non-critical frames, the sender module 49 will send out a Purge Synchronization Message to the receiver 23 to instruct it to ignore the purged frames (i.e., not requesting and/or waiting for these frames) (109).

If the retransmission buffer 45 exceeds the Video Source Pause Threshold (111), the sender QoS manager 43 will instruct the encoder to skip incoming video frames and pause the outgoing video streams (113).

When video is paused for more than an Active Purge Threshold Time (115), the sender QoS manager 43 will initiate an Active Purge process, which may include:
Sending out a Purge Synchronization Message to the receiver 23 and instructing the receiver 23 which frames are purged (117);
Purging all the data packets from the retransmission buffer 45 (119); and/or
Requesting an intra-frame from the video encoder 39 as the next incoming frame (121).

Sender module 49 may drop all non-intra-frame data packets incoming from the encoder 39 until it gets an intra-frame. The sender module 49 then transmits the intra-frame to the network 17 as well as stores in the retransmission buffer 45 and restarts the process.

The sender QoS manager 43 also monitors the quality of the sender-to-receiver connection. A retransmission system introduces bandwidth overhead to the network connection. In certain cases, especially when the network bandwidth is limited and loss condition is serious, the retransmission overhead may stress the connection to the point that the overall system becomes unstable. In the present example, if quality falls under Retransmission Off Threshold and lasts longer than a Retransmission Off Threshold Time, the sender QoS manager 43 transmits a Retransmission Off message to the receiver 23 to turn off retransmission operations. If the retransmission operation is off and the channel quality exceeds a Retransmission On Threshold for longer than a Retransmission On Threshold Time, the sender module 49 transmits a Retransmission On message to the receiver 23 to resume retransmission operations.

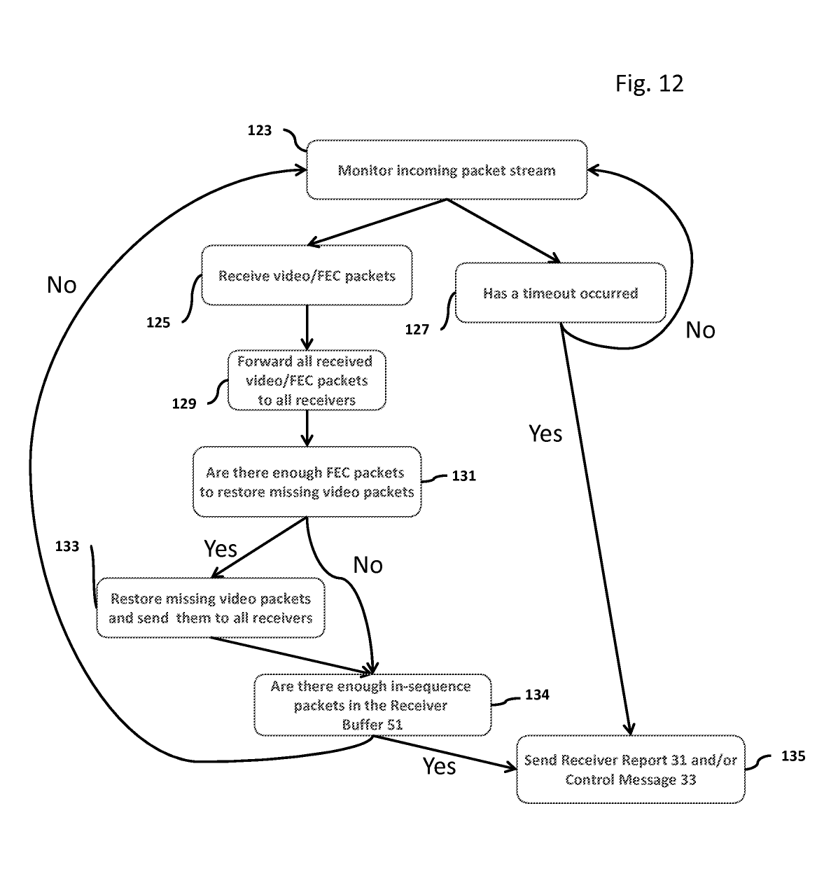

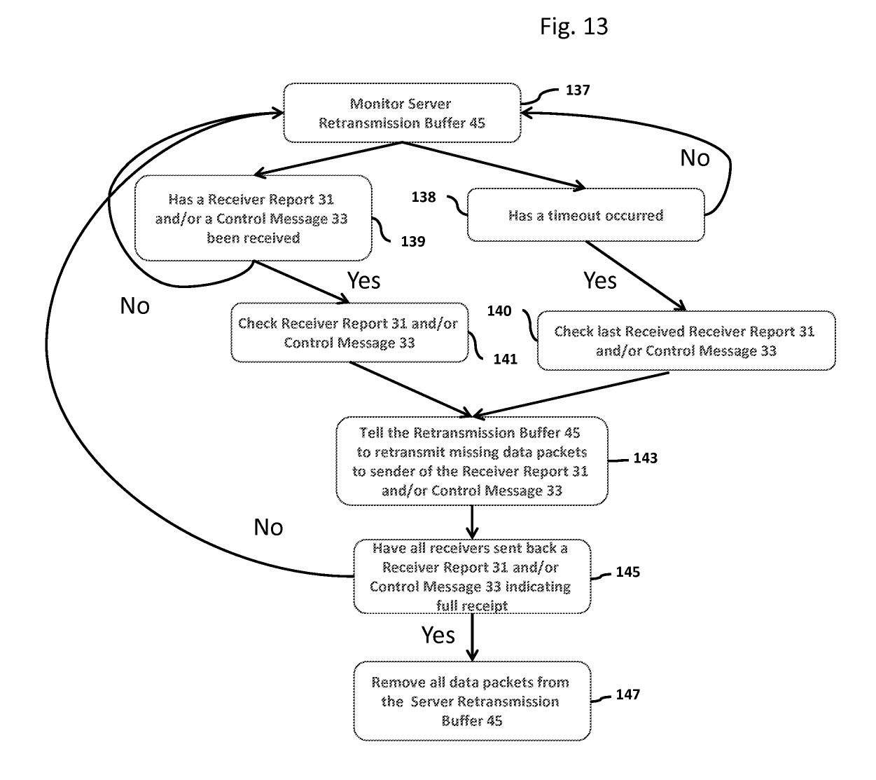

FIGS. 12 and 13 show another example of the QoS managers of the present system as found in a server. It is understood that when using the present system in the context of a server, one of ordinary skill could scale up the number of QoS managers and buffers as found in FIGS. 9-11 to reflect the number of users of the system. However, FIGS. 12 and 13 show flow charts illustrating examples of a receiver QoS manager and a sender QoS manager found in a server when only a single retransmission buffer is utilized by the server for the multiple receivers intended for receiving video transmission from a single source.

In FIG. 12, the receiver QoS manager 61 of the server monitors the incoming packet stream (123). The system continues to monitor the incoming packet stream until either a timeout occurs (127) or it receives video and FEC packets (125). The new video and FEC packets are forwarded to all intended receivers (129). The receiver QoS manager 61 of the server will also determine whether there are enough FEC packets to restore any missing or damaged video packets (131). If so, it will repair those and send them to all intended receivers (133). After repairing the missing or damaged video packets or if there are not enough FEC packets to restore the missing or damaged video packets, the receiver QoS manager 61 determines whether there are enough in-sequence packets in the receiver buffer 51 (134). If not, it continues to monitor the incoming packet stream (123). The receiver QoS manager 61 of the server will send out a receiver report 31 and/or control message 33 when either a timeout has occurred or there are enough in-sequence packets in the receiver buffer 51 (135).

In FIG. 13, the sender QoS manager 43 of the server monitors the server retransmission buffer 45 (137) until it receives a receiver report 31 and/or control message 33 (139) or has a timeout event (138). The sender QoS manager 43 of the server then checks the receiver report 31 and/or control message 33 for any reports of missing data packets (141). If a timeout event is triggered, the sender QoS manager 43 of the server checks the last available receiver report 31 and/or control message 33 for any reports of missing data packets (140). It then instructs the server retransmission buffer 45 to retransmit any missing data packets to the sender of the respective receiver report 31 and/or control message 33 (143). Finally, the sender QoS manager 43 of the server will verify if all receivers have sent a receiver report 31 and/or control message 33 indicating full receipt of the data packets (145). If some receivers have not indicated full reception of the data packets, the sender QoS manager 43 of the server will continue to monitor the server retransmission buffer 45 (137). Otherwise, it will remove all data packets from the server retransmission buffer 45 (147).

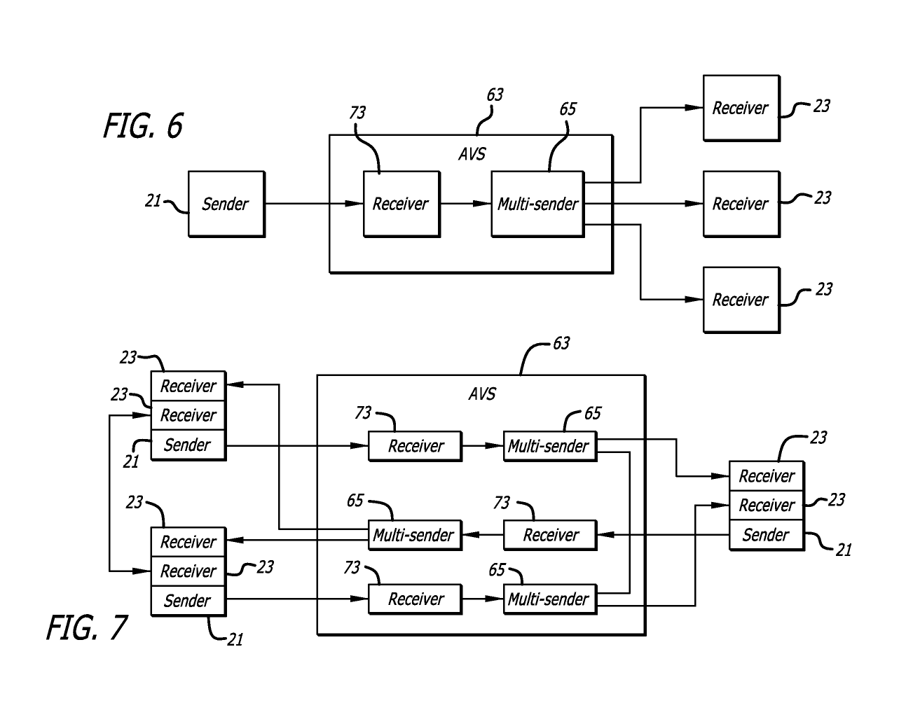

FIGS. 6 and 7 show multipoint examples of the present method and system. Specifically, FIG. 6 is a flow chart that generally illustrates a point-to-multipoint example of the present system. FIG. 7 is a flow chart that schematically illustrates a multiuser conference example of the present system, which could be used for a video conference. Despite parties in FIG. 7 having to be both senders 21 and receivers 23, the systems and methods described above are not affected. Each device, whether mobile or fixed, has the ability to be both a sender module 49 and a receiver 23.

In FIGS. 6 and 7, all senders 21 transmit data packets to an AVS 63. These senders 21 utilize the same method and system as the sender module 49 described above (see FIG. 4). The receivers 23 and AVS receivers 73 of a multi-point system utilize the same method and system as the receiver 23 previously described (see FIG. 5).

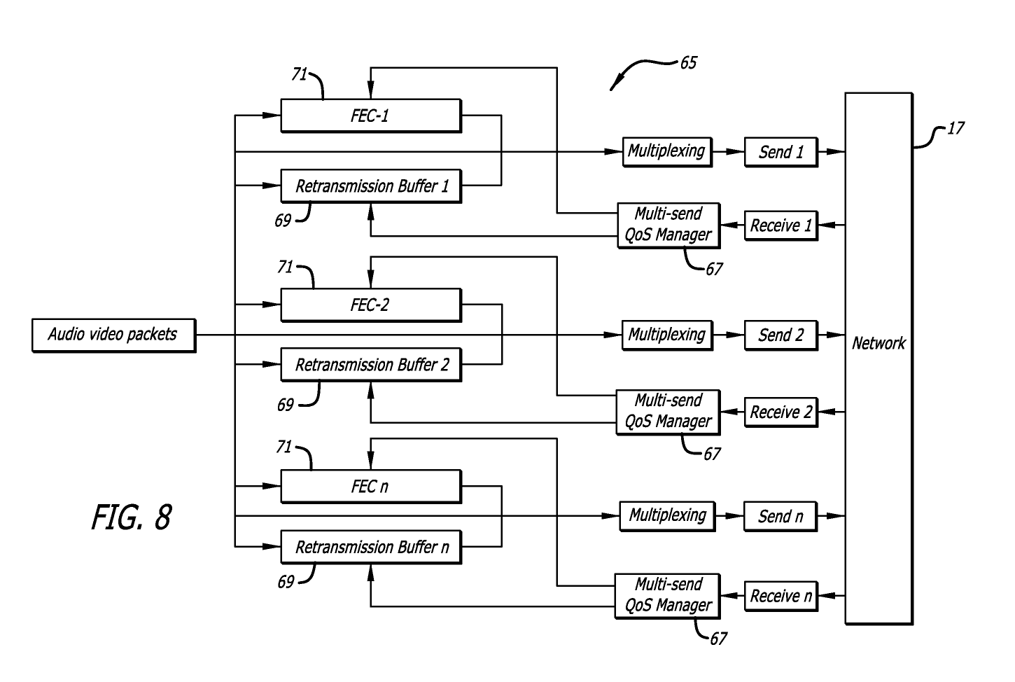

In the present examples, the AVS 63 includes a multi-senders 65 to coordinate the signals of various senders 21. FIG. 8 is a simplified flow chart that schematically illustrates an example of a multi-sender 65 in the present system. In the present example, the multi-sender 65 receives data packets and FEC repair packets from a respective AVS receiver 73. Each multi-sender 65 then places the data packets in retransmission buffers 69 and the FEC repair packets in FEC buffers 71 for each respective AVS receiver 73. The multi-sender 65 then transmits the data packets and FEC repair packets to the respective receivers 23. Each receiver 23 interacts and processes packages with the multi-sender 65 as if it was interacting with an individual sender module 49, as described previously. This allows for the multi-sender 65 to detect heterogeneous downlink network conditions and to provide optimal protection and dynamic adjustments for each individual receiver 23. In the present example, a single multi-send QoS manager 67 maintains the system similar to the sender QoS manager 43 previously described. In other examples, multiple sender QoS managers 43 may be used.

While the foregoing has described what is considered to be the best mode and/or other examples, it is understood that various modifications may be made therein and that the subject matter disclosed herein may be implemented in various forms and examples, and that they may be applied in numerous other applications, combinations, and environments, only some of which have been described herein. Those of ordinary skill in that art will recognize that the disclosed aspects may be altered or amended without departing from the true spirit and scope of the subject matter. Therefore, the subject matter is not limited to the specific details, exhibits, parameters, and illustrated examples in this description. It is intended to protect any and all modifications and variations that fall within the true scope of the advantageous concepts disclosed herein.

We claim:

1. A computer program product, comprising a computer usable medium having a computer readable program code embodied therein, said computer readable program code adapted to be executed to implement a method for providing network error resiliency, said method comprising:
receiving a video transmission;
encoding the video transmission into source video packets;
storing the source video packets in a retransmission buffer;
using forward error correction to encode the source video packets into FEC repair packets;
transmitting the source video packets and the FEC repair packets, wherein a receiver processes the source video packets and the FEC repair packets; and
receiving a receiver report transmitted by the receiver.

2. The computer program product according to claim 1, wherein the receiver report comprises a report of the source video packets that were not received and source video packets that could not be repaired by the FEC repair packets.

3. The computer program product according to claim 1, wherein the source video packets in the retransmission buffer are transmitted if the receiver report is not received within a certain amount of time.

4. The computer program product according to claim 2, wherein the retransmission buffer removes all source video packets that were received based on the receiver report.

5. The computer program product according to claim 4, wherein any source video packets remaining in the retransmission buffer are transmitted.

6. The computer program product according to claim 5, wherein the receiver report further comprises network loss conditions.

7. The computer program product according to claim 6, wherein the network loss conditions comprise round trip time measurements, retransmission buffer lengths, and retransmission rates.

8. The computer program product according to claim 1, wherein a sender manager monitors the source video packets in the retransmission buffer in relation to at least one threshold.

9. The computer program product according to claim 8, wherein the threshold comprises at least one of a purge threshold, a video source pause threshold, and active purge threshold.

10. A method for providing network error resiliency, said method comprising:
receiving a video transmission;
encoding the video transmission into source video packets;
storing the source video packets in a retransmission buffer;
using forward error correction to encode the source video packets into FEC repair packets;
transmitting the source video packets and the FEC repair packets, wherein a receiver processes the source video packets and the FEC repair packets; and
receiving a receiver report transmitted by the receiver.

11. The computer program product according to claim 10, wherein the receiver report comprises a report of the source video packets that were not received and source video packets that could not be repaired by the FEC repair packets.

12. The computer program product according to claim 10, wherein the source video packets in the retransmission buffer are transmitted if the receiver report is not received within a certain amount of time.

13. The computer program product according to claim 10, wherein the retransmission buffer removes all source video packets that were received based on the receiver report.

14. The computer program product according to claim 13, wherein any source video packets remaining in the retransmission buffer are transmitted.

15. The computer program product according to claim 14, wherein the receiver report further comprises at least one network loss condition.

16. The computer program product according to claim 15, wherein the network loss condition comprises at least one of a round trip time measurement, a retransmission buffer length, and a retransmission rate.

17. The computer program product according to claim 10, wherein a sender manager monitors the source video packets in the retransmission buffer in relation to at least one threshold.

18. The computer program product according to claim 17, wherein the threshold comprises at least one of a purge threshold, a video source pause threshold, and active purge threshold.

19. A computer program product, comprising a computer usable medium having a computer readable program code embodied therein, said computer readable program code adapted to be executed to implement a method for providing network error resiliency, said method comprising:
receiving video packets and FEC repair packets;
holding the video packets in a receiver buffer;
holding the FEC repair packets in a FEC decoder;
repairing the video packets using the FEC repair packets;
transmitting a request for a retransmission of any video packets that could not be repaired by the FEC repair packets;
receiving retransmitted video packets and retransmitted FEC repair packets;
decoding the video packets and the repaired video packets; and
rendering received video packets and repaired video packets into a video demonstration.

20. The computer program product according to claim 19, wherein a request for a retransmission of any video packets that could not be repaired comprises a receiver report.

21. The computer program product according to claim 20, wherein the receiver report further comprises network loss conditions.

22. The computer program product according to claim 21, wherein the network loss conditions comprise round trip time measurements, retransmission buffer lengths, and retransmission rates.

23. The computer program product according to claim 22, wherein a receiver manager monitors the video packets in the receiver buffer in relation to at least one threshold.

24. The computer program product according to claim 23, wherein the receiver report further comprises information from the receiver manager regarding at least one of the thresholds.

25. The computer program product according to claim 24, wherein the threshold comprises at least one of a timeout occurrence, a receiver buffer length, and a new video frame.

26. A method for providing network error resiliency, said method comprising:
receiving video packets and FEC repair packets;
holding the video packets in a receiver buffer;
holding the FEC repair packets in a FEC decoder;
repairing the video packets using the FEC repair packets;
transmitting a request for a retransmission of any video packets that could not be repaired by the FEC repair packets;
receiving retransmitted video packets and retransmitted FEC repair packets;
decoding the video packets and the repaired video packets; and
rendering received video packets and repaired video packets into a video demonstration.

27. The computer program product according to claim 26, wherein a request for a retransmission of any video packets that could not be repaired comprises a receiver report.

28. The computer program product according to claim 27, wherein the receiver report further comprises network loss conditions.

29. The computer program product according to claim 28, wherein the network loss conditions comprise round trip time measurements, retransmission buffer lengths, and retransmission rates.

30. The computer program product according to claim 29, wherein a receiver manager monitors the video packets in the receiver buffer in relation to at least one threshold.

31. The computer program product according to claim 30, wherein the receiver report further comprises information from the receiver manager regarding at least one of the thresholds.

32. The computer program product according to claim 31, wherein the threshold comprises at least one of a timeout occurrence, a receiver buffer length, and a new video frame.

33. A computer program product, comprising a computer usable medium having a computer readable program code embodied therein, said computer readable program code adapted to be executed to implement a method for providing network error resiliency, said method comprising:
receiving video transmission from at least two sources, wherein a video transmission comprises video packets and FEC repair packets;
transmitting each video transmission to one or more receivers;
repairing the video packets using the FEC repair packets;
transmitting the repaired video packets to one or more receivers; and
sending a receiver report to the video transmission source.

34. The computer program product according to claim 33, wherein the receiver report comprises a report of the video packets that were not received and video packets that could not be repaired by the FEC repair packets.

35. The computer program product according to claim 34, wherein the receiver report further comprises network loss conditions.

36. The computer program product according to claim 35, wherein the network loss conditions comprise round trip time measurements, retransmission buffer lengths, and retransmission rates

37. A computer program product, comprising a computer usable medium having a computer readable program code embodied therein, said computer readable program code adapted to be executed to implement a method for providing network error resiliency, said method comprising:
receiving video packets and FEC repair packets from at least two sources;
holding the video packets in a singer buffer;
holding the FEC repair packets in a single FEC decoder;
receiving receiver reports from at least one receiver, wherein a receiver report comprises requests for retransmission of missing video packets at a receiver;
transmitting requested missing video packets to each corresponding receiver;
receiving receiver reports from each receiver, wherein each receiver report does not comprise a request for retransmission of missing video packets; and
removing all video packets from the single buffer.

38. The computer program product according to claim 37, wherein the receiver report further comprises network loss conditions.

39. The computer program product according to claim 38, wherein the network loss conditions comprise round trip time measurements, retransmission buffer lengths, and retransmission rates.

40. The computer program product according to claim 39, wherein a receiver manager monitors the video packets in the receiver buffer in relation to at least one threshold.

41. The computer program product according to claim 40, wherein the receiver report further comprises information from the receiver manager regarding at least one of the thresholds.

42. The computer program product according to claim 41, wherein the threshold comprises at least one of a timeout occurrence and a receiver buffer length.
